(19) United States
(12) Patent Application Publication
(10) Pub. No.: US 2006/0071901 A1
(43) Pub. Date: Apr. 6, 2006

(54) Graphic illumination for contact-less control

(76) Inventor: Mark G. Feldman, Farmington Hills, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/958,915

(22) Filed: Oct. 5, 2004

(51) Int. Cl. G09G 3/36

(52) U.S. Cl. 345/102

(57) ABSTRACT

A contact-less control includes a panel with at least one back-lit graphic, a sensor circuit; at least one carrier circuit, and a light source connected to the carrier circuit. The light source is connected to the carrier circuit and is positioned within an aperture in the sensor circuit.

### BACKGROUND OF THE INVENTION

1. Field of the Invention

The present invention relates to a graphic assembly for the graphic illumination for contact-less controls.

2. Background Art

Many types of control panels incorporate illuminated graphics into the control panel in order to allow the user to readily see what is being activated, or non-activated, by the control on the panel. Currently, these controls currently use field effect, capacitance or resistive sensors.

The designs of the currently available graphic assemblies that are used to back light, or illuminate, graphics on a control panel have a number of drawbacks. One drawback is caused by the undesirable refraction and/or reflection of light that occurs in the prisms within the graphic assembly. This undesirable refraction and/or reflection of light causes shadows to occur in adjacent graphics in the control panel.

Another drawback is that the current products that use field effect, capacitance or resistive sensors frequently have uneven light intensity which makes viewing of the panel more difficult.

A still further drawback is that the control panel has complicated wiring that connects a source of illumination to a power source. When the source of illumination must be replaced, various parts of the control panel must be removed, often causing damage to the control panel itself.

### SUMMARY OF THE INVENTION

In one aspect, the present invention relates to a contact-less control that has at least one panel with at least one back-lit graphic; at least one sensor flexible printed circuit; and, at least one carrier flexible printed circuit having at least one LED.

According to one aspect, the present invention relates to a contact-less control having a panel with at least one back-lit graphic; a sensor circuit; a carrier circuit; and, a light source operatively connected to the carrier circuit. The at least one light source is connected to the carrier circuit such that when an appropriate signal is received by the light source, the light source is illuminated.

In certain embodiments, the panel includes at least one generally opaque member through which light cannot pass. The opaque member defines the at least one graphic design formed in the panel where the graphic design is at least translucent such that light can pass therethrough.

The sensor circuit defines at least one aperture that extends from an inner surface to an outer surface of the sensor circuit. The light source on the carrier sensor is positioned within the aperture. The aperture in the sensor circuit generally has a desired dimension that allows for optimum light transmission from a light source at a desired projection. In certain embodiments, the light source comprises a LED type of light.

According to another aspect, the present invention relates to a contact-less control where the graphic design includes at least one lens formed into an inner surface of the back-lit panel where the lens is in alignment with the light source on the carrier sensor.

The advantages associated with embodiments of the present invention are numerous. For example, the preferred embodiment allows the control panel to have multiple illuminated graphics that are sharp, clear, and substantially without shadows caused by adjacent or nearby graphics. Further, the contact-less control allows multiple graphics to be individually illuminated. Also, the contact-less control allows each individually illuminated graphic to be specifically tailored to the desired end needs, including individual brightness, or light intensity; color of illumination; and other such parameters.

The features and advantages of the present invention are readily apparent from the following detailed description of the preferred embodiment when taken in connection with the accompanying drawings.

### BRIEF DESCRIPTION OF THE DRAWINGS

FIG. 1 is an exploded perspective of one embodiment of a control panel with contact-less controls.

FIG. 2 is an exploded perspective of a portion of one embodiment of a control panel with contact-less controls showing a panel with back-lit graphics and a LED carrier flexible printed circuit.

FIG. 3 is an exploded perspective of a portion of one embodiment of a control panel with contact-less controls showing a panel with back-lit graphics (in phantom) and a LED carrier flexible printed circuit.

FIG. 4 is a cross-sectional view of one embodiment of a control panel with contact-less controls.

### DETAILED DESCRIPTION OF THE PREFERRED EMBODIMENT

Referring first to the Figures, it is to be understood that certain features in the drawings have been enlarged for ease of illustration and the drawings and the elements thereof are not necessarily in proper proportion. However, those of ordinary skill in the art will readily understand such details. In the drawings, like numerals are used to indicate like elements throughout.

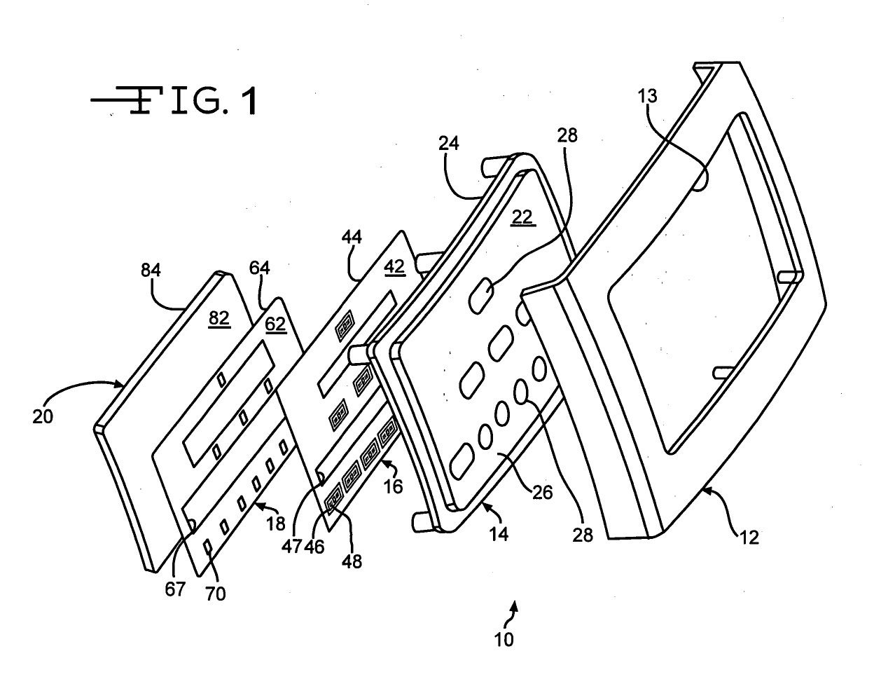

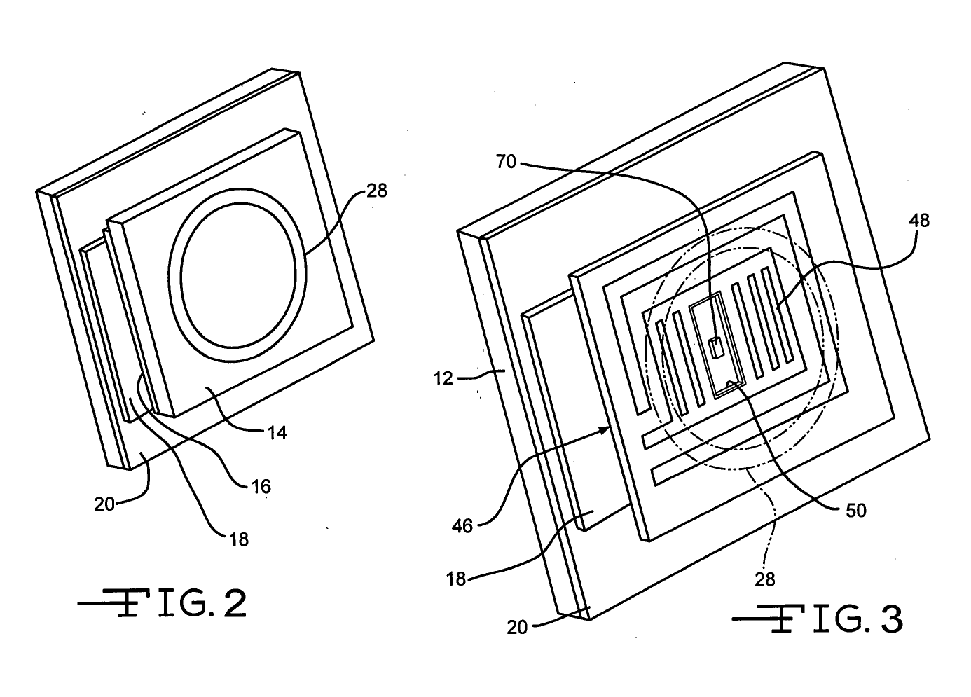

FIG. 1 shows one embodiment of a control panel 10 with contact-less controls. The control panel 10 includes such components as a bezel, or frame, 12, a back-lit panel 14, a sensor circuit 16, an LED carrier circuit 18, and a back plate 20. It is to be understood that the sensor circuit 16 and the carrier circuit 18 generally are comprised of circuits which known to provide excellent electrical conductivity. Thus, the sensor circuit 16 and the carrier circuit 18 are electrically connected using any suitable bonding process that is well understood by those skilled in the art of integrated circuit manufacturing. In the embodiment shown, the sensor circuit 16 and the carrier circuit 18 comprise flexible printed circuits.

It is also to be understood that the frame 12 and back plate 20 can be comprised of any suitable material. The frame 12 and back plate 20 can have any suitable shape that secures the components of the control panel 10 to the apparatus in which it is installed. In certain embodiments, the present invention is suitable for a control panel in a motor vehicle or aircraft, or other such end uses where an operator desires to control an apparatus under conditions where there is insufficient ambient light to readily see and select a desired control.

The frame 12 generally defines at least one opening 13 through which the panel 14 can be seen. While not shown, it should be understood that, in certain embodiments, a protective covering can be placed in the opening 13.

For ease of illustration, the back-lit panel 14 is described herein as having an outer planar surface 22 and an inner planar surface 24. It should be understood that the terms “outer” and “inner” refer to the relative placement of the planar surfaces of the back-lit panel 14 with respect to the control panel 10 as it is assembled for installation in the end use and is accessible to the end user. The back-lit panel 14 includes at least one generally opaque member 26 through which light cannot pass. The opaque member 26 has at least one graphic design 28 formed therein.

In many embodiments, the graphic designs 28 are arranged in desired patterns, such as controls for a vehicle interior. In certain embodiments, the graphic design 28 is at least translucent such that light can pass therethrough. It is to be understood that the graphic design 28 can correspond to visual indications such as hatch marks, numbers and/or letters, symbols, and the like.

It is to be further understood that, in certain embodiments, the back-lit panel 14 and the graphic designs 28 can be constantly illuminated when the apparatus is being operated. Also, in certain embodiments, the graphic design 28 can correspond to an indicator that only becomes illuminated under certain circumstances, including, for example, warning lights, low fuel indicators, and the like. It is to be further understood that the back-lit panel 14 can be fabricated using such suitable methods as paint and laser etching; molding in the applique, or graphic; or second shot over mold processing.

The sensor circuit 16 generally comprises at least one flexible printed circuit that has an outer planar surface 42 and an inner planar surface 44. It should be understood that the terms “inner” and “outer” refer to the relative placement of the planar surfaces of the sensor circuit 16 with respect to the control panel 10 as it is assembled for installation in the end use and is accessible to the end user. The sensor circuit 16 includes at least one suitably designed circuit 46 having at least one or more sensor traces 48, as schematically shown in the figures. It is to be understood that, in many embodiments, the sensor circuit 16 comprises a plurality of circuits 46 and sensor tracers 48 that are arranged in a configuration that coincides with a desired pattern of graphic designs 28 on the back-lit panel 14. In the embodiment shown, each sensor tracer 48 is in co-axial alignment with a corresponding graphic design 28 on the back-lit panel 14. The sensor tracers 48 are operatively connected to the apparatus for receiving appropriate signals.

Referring now to FIG. 3, an exploded schematic illustration of one circuit 46 is shown as being substantially surrounded by a corresponding sensor tracer 48. The circuit 46 defines at least one opening, or aperture, 50 that extends from the inner surface 42 to the outer surface 44 of the sensor circuit 16. The aperture 50 is positioned is a spaced apart relationship to the sensor tracer 48. In the embodiment shown, the aperture 50 is substantially surrounded by the sensor tracer 48. In certain embodiments, the flexible sensor circuit 16 thus defines a plurality of apertures 50 where each aperture 50 coincides with at least one graphic design 28 on the back-lit panel 14, as can be seen in FIG. 1. The aperture 50 in the sensor circuit 16 generally has a desired dimension that allows for optimum light transmission from a light source, as will be explained in detail below.

Referring again to FIG. 1, the carrier circuit 18 generally comprises at least one flexible printed circuit that has an outer planar surface 62 and an inner planar surface 64. It should be understood that the terms “inner” and “outer” refer to the relative placement of the planar surfaces of the carrier circuit 18 with respect to the control panel 10 as it is assembled for installation in the end use and is accessible to the end user. The carrier circuit 18 includes at least one light source 70 that is suitably connected thereto such that when the appropriate signal is received by the light source 70, the light source is illuminated. It is to be understood that the light source 70 can be illuminated at all times. Alternatively, the light source 70 can be illuminated in response to certain other appropriate signals, such as when a warning or other type of signal is to be given to the end user. In the embodiment shown, the light source 70 comprises an LED type of light.

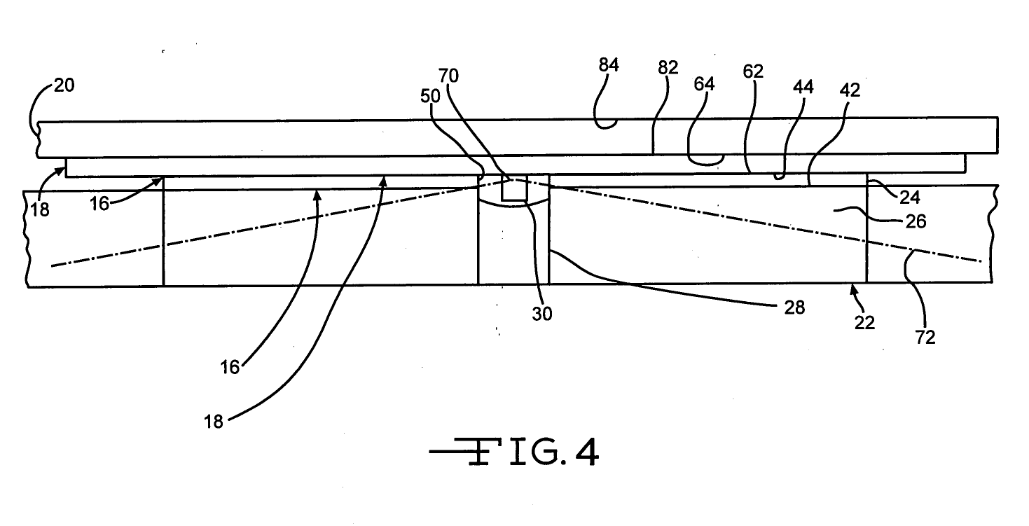

The LED light source 70 allows ample illumination without generating undesirable heat. As best seen in the schematic illustration in FIG. 4, light 72 radiates from the LED light source 70 at a desired projection through the aperture 50. For example, the angle of projection illustrated in FIG. 4 is about 160°. It should be understood that the desired angle of projection will be, at least in part, determined by the characteristics of the graphic design 28 which the light source 70 will illuminate. While the embodiment shown depicts one LED light source 70 positioned within the aperture 50 in the sensor circuit 16, in other embodiments, it may be desired to have a plurality of LED light sources 70 positioned within the aperture 50. Such use of the plurality of LED light sources 70 will depend, at least in part, on the dimensions of the graphic design 28 that is to be illuminated.

Also, in certain embodiments, as shown in FIG. 4, the graphic design 28 can include a lens 30 formed into the inner surface 24 of the back-lit panel 14. The lens 30 has a suitably shaped surface that aids in directing the light passing therethrough. Thus, the lens 30 shown in FIG. 4 has a generally concave dimension such that the light 72 is diverged into a wide angle to illuminate a wide area of the graphic. In other embodiments, the lens 30 generally can have a convex dimension (not shown) such that the light 72 is focused, or converged, into a narrowed path. It is to be understood, however, that the structure of the control panel 10 provides for a very short optical path and thus, very low diffraction. If lenses are desired in certain embodiments, the lens 30 is self-aligned with the graphic design 28, hence no additional alignment step is required.

Referring again to FIG. 1, it is to be understood that the sensor circuit 16 and the carrier circuit 18 can optionally further include at least one or more “cut out” areas 47 and 67, respectively, in order to save on material and/or weight of the circuits.

The control panel can have include the back plate 20, as shown in the figures where such back plate 20 has an outer planar surface 82 and an inner planar surface 84. It should be understood that the terms “inner” and “outer” refer to the relative placement of the planar surfaces of the back plate 20 with respect to the control panel 10 as it is assembled for installation in the end use and is accessible to the end user.

It should be noted that the present invention is not limited to the examples shown, but rather, that it is to include the spirit and scope of the invention. For example, various iterations of the contact-less control have been contemplated which include a control panel with a very low package height.

It is therefore one object of this invention to provide a contact-less control retains a desirable intensity of illumination while improving on the sharpness of the graphic.

It is a further object of this invention to provide a contact-less control that retains a desirable intensity of illumination while lessening shadows within the control.

It is a further object to provide a contact-less control that provides one LED per graphic without causing additional heat build-up within a panel which contains such control.

Still another object of this invention is to provide a low cost, contact-less control design.

It should be understood that the various features of different embodiments may be used as shown with the specific embodiments illustrated or with other features shown and described with other control panels arrangements. Thus, a control panel can be configured with one or more of the features as disclosed herein. It should also be understood that the trim panels or housings to which the control panels are mounted can be any suitable trim component in the vehicle, such as door panels, armrests, instrument panels, center consoles, seats, overhead consoles, and roofs.

The control panel is also applicable to all types of electronic devices, optical devices, touch/pressure devices and any other type of sensor or electrical component.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A contact-less control comprising: at least one panel with at least one back-lit graphic; at least one sensor circuit; at least one carrier circuit; and, at least one light source operatively connected to the at least one carrier circuit, the at least one light source being suitably connected to the carrier circuit whereby, when an appropriate signal is received by the light source, the light source is illuminated.

2. The contact-less control of claim 1, wherein panel includes at least one generally opaque member through which light cannot pass, the opaque member defining the at least one graphic design formed in the panel, and wherein the graphic design is at least translucent such that light can pass therethrough.

3. The contact-less control of claim 1, wherein the sensor circuit defines at least one aperture that extends from an inner surface to an outer surface of the sensor circuit, wherein the at least one light source on the carrier sensor is positioned within the at least one aperture.

4. The contact-less control of claim 3, wherein the aperture in the sensor circuit generally has a desired dimension that allows for optimum light transmission from a light source at a desired projection of about 160° through the aperture.

5. The contact-less control of claim 1, wherein the light source comprises a LED type of light.

6. The contact-less control of claim 1, wherein the graphic design includes at least one lens formed into an inner surface of the panel, the lens being in alignment with the light source on the carrier sensor.

7. The contact-less control of claim 7, wherein the lens has a generally concave dimension such that the light is diverged into a wide angle to illuminate a wide area of the graphic.

8. The contact-less control of claim 7, wherein the lens has a generally convex dimension such that the light is focused, or converged, into a narrowed path.

9. The contact-less control of claim 7, wherein the lens is self-aligned with the graphic design.

10. The contact-less control of claim 1, wherein at least one of the sensor circuit and the carrier circuit further define at least one or more “cut out” areas.

11. The contact-less control of claim 1, wherein the sensor circuit comprises a flexible printed circuit.

12. The contact-less control of claim 1, wherein the carrier circuit comprises a flexible printed circuit.

13. The contact-less control of claim 1, wherein the sensor circuit includes at least one suitably designed circuit having at least one or more sensor traces, each sensor tracer being in co-axial alignment with a corresponding graphic design on the panel.

14. A contact-less control comprising:
at least one panel with at least one back-lit graphic, the panel includes at least one generally opaque member through which light cannot pass, the opaque member defining the at least one graphic design formed in the panel, and wherein the graphic design is at least translucent such that light can pass therethrough;
at least one sensor circuit, the sensor circuit defining at least one aperture that extends from an inner surface to an outer surface of the sensor circuit, wherein the light source on the carrier sensor is positioned within the at least one aperture;
at least one carrier circuit; and,
at least one light source operatively connected to the at least one carrier circuit, the at least one light source being suitably connected to the carrier circuit whereby, when an appropriate signal is received by the light source, the light source is illuminated.

15. The contact-less control of claim 14, wherein the light source comprises a LED type of light.

16. The contact-less control of claim 14, wherein the graphic design includes at least one lens formed into an inner surface of the panel, the lens being in alignment with the light source on the carrier sensor.

17. The contact-less control of claim 16, wherein the lens is self-aligned with the graphic design.

18. The contact-less control of claim 14, wherein at least one of the sensor circuit and the carrier circuit further define at least one or more “cut out” areas.

19. The contact-less control of claim 14, wherein the sensor circuit comprises a flexible printed circuit and wherein the carrier circuit comprises a flexible printed circuit.
